(19) United States
(12) Patent Application Publication
(10) Pub. No.: US 2026/0300545 A1
(43) Pub. Date: Oct. 1, 2026

(54) PRODUCING A DE-ANONYMIZED DATASET FOR TRAINING ARTIFICIAL INTELLIGENCE (AI) MODELS

(71) Applicant: International Business Machines Corporation, Armonk, NY (US)

(72) Inventors: Youngja Park, Princeton, NJ (US); Kevin Eykholt, White Plains, NY (US); Jiyong Jang, Chappaqua, NY (US)

(21) Appl. No.: 19/097,695

(22) Filed: Apr. 1, 2025

(51) Int. Cl. G06F 21/62; G06N 20/00

(52) U.S. Cl. CPC G06F 21/6254; G06N 20/00

(57) ABSTRACT

A method, according to one embodiment, includes generating data templates. The generating comprises: identifying anonymized fields within an anonymized dataset, and determining field types of the identified anonymized fields. The method further includes generating first replacement values for the anonymized fields, and producing a de-anonymized dataset, where the producing the first de-anonymized dataset comprises replacing the anonymized fields in the data templates with the generated first replacement values. The method further includes training an artificial intelligence (AI) model with the first de-anonymized dataset. A computer program product, according to another embodiment, includes one or more computer-readable storage media, and program instructions stored on the one or more computer-readable storage media to perform the foregoing method.

### BACKGROUND

The present invention relates to artificial intelligence (AI) models, and more specifically, this invention relates to training AI models.

AI models are typically trained using a collection of data commonly referred to as a training dataset. One type of AI model, Large language models (LLMs), are generally trained using a two-step process. First the model is pre-trained on a large volume of diverse training data to ensure that the model is able to sufficiently generalize across multiple tasks. Then, the pre-trained model is fine-tuned on a much smaller set of specialized data to further improve performance of the model with respect to a specific task, such as classification, generation, and/or reasoning, or the task domain.

### SUMMARY

A method, according to one embodiment, includes generating data templates. The generating comprises: identifying anonymized fields within an anonymized dataset, and determining field types of the identified anonymized fields. The method further includes generating first replacement values for the anonymized fields, and producing a de-anonymized dataset, where the producing the first de-anonymized dataset comprises replacing the anonymized fields in the data templates with the generated first replacement values. The method further includes training an artificial intelligence (AI) model with the first de-anonymized dataset.

A computer program product, according to another embodiment, includes one or more computer-readable storage media, and program instructions stored on the one or more computer-readable storage media to perform the foregoing method.

A computer system, according to another embodiment, includes a processor set, one or more computer-readable storage media, and program instructions stored on the one or more computer-readable storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of FIG. 2A, in accordance with one embodiment of the present invention.

FIG. 3 is a table, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for producing a de-anonymized dataset for training an AI model.

In one general embodiment, a method includes generating data templates. The generating comprises: identifying anonymized fields within an anonymized dataset, and determining field types of the identified anonymized fields. The method further includes generating first replacement values for the anonymized fields, and producing a de-anonymized dataset, where the producing the first de-anonymized dataset comprises replacing the anonymized fields in the data templates with the generated first replacement values. The method further includes training an artificial intelligence (AI) model with the first de-anonymized dataset.

In another general embodiment, a computer program product includes one or more computer-readable storage media, and program instructions stored on the one or more computer-readable storage media to perform the foregoing method.

In another general embodiment, a computer system includes a processor set, one or more computer-readable storage media, and program instructions stored on the one or more computer-readable storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as de-anonymization code of block 150 for producing a de-anonymized dataset for training an AI model. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

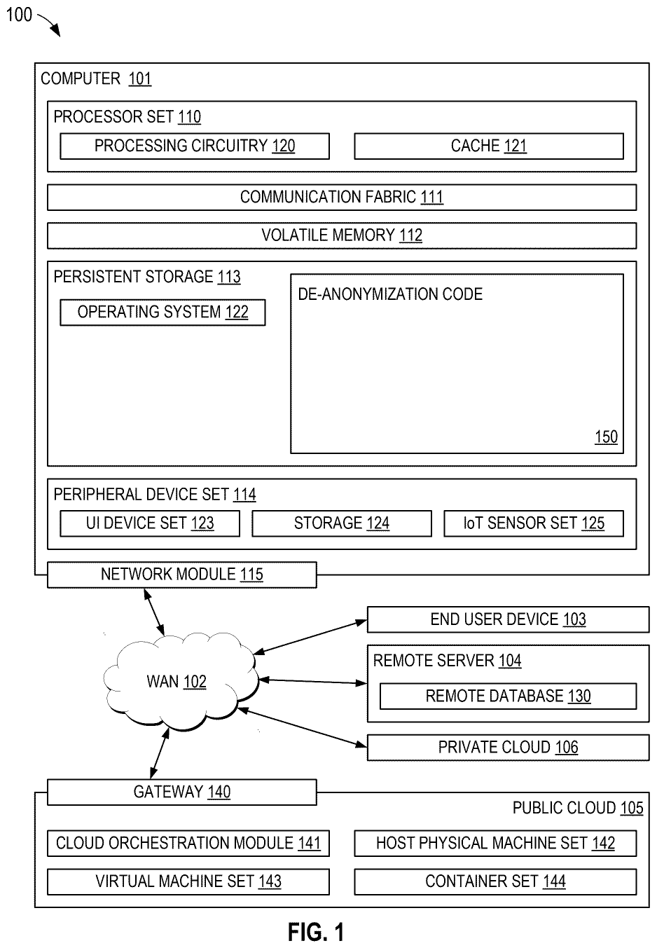

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, AI models are typically trained using a collection of data commonly referred to as a training dataset. One type of AI model, Large language models (LLMs), are generally trained using a two-step process. First the model is pre-trained on a large volume of diverse training data to ensure that the model is able to sufficiently generalize across multiple tasks. Then, the pre-trained model is fine-tune on a much smaller set of specialized data to further improve performance of the model with respect to a specific task, such as classification, generation, and/or reasoning, or specific task domain. For example, one might fine-tune a model trained on general coding data (e.g. C++, PYTHON, JAVA) to do better on JAVASCRIPT or C because that is the target domain that the model will be deployed in.

The relatively large size and complexity of state-of-the-art AI models, required computing resources, and lack of expertise make it unfeasible for average users to train an LLM, and, thus, they utilize the resources of third party AI and cloud vendors for training their models. However, the training data owned by a user may be sensitive due to privacy concerns and/or the proprietary nature of the data. As such, the data is subjected to an anonymization process before being shared with third parties. These conventional anonymization processes have critical drawbacks that create issues detailed below.

A first issue that results from conventional anonymization processes is based on the fact that data anonymization diminishes the usefulness of the data for fine-tuning LLMs. An LLM trained on anonymized data learns how to generate text resembling the anonymized data, not the original non-anonymized data and performs relatively poorly when deployed. Further, anonymized data increases the difficulty of evaluation, both for the third-party training service provider and the data owner. A second issue that results from conventional anonymization processes is based on the fact that data anonymization is a computer resource intensive and time-consuming process. To minimize information loss in the anonymized data, it is essential for the anonymized data to preserve the data type information and entity-specific patterns. This adds significant burden to data owners. In summary it is very difficult, and to this point unfeasible, to automatically redact all sensitive data while preserving the data characteristics required for training a high performing LLM. For context, a primary issue is based on the fact that conventional anonymization aims to prevent others from learning about the original data (an intended goal of the anonymization), but this necessarily diminishes learning. Despite conventional techniques enabling data anonymization to some degree, they fail to maintain the distribution of the underlying data, which is critical for training high performance LLMs. Accordingly, there exists a longstanding need for minimize information loss in anonymized data that is used to train an AI model.

In sharp contrast to the deficiencies of conventional techniques described above, the embodiment and approaches described herein mitigate the issues described above by enabling synthetic data generation techniques that create realistic training data from anonymized data. These techniques aim at both reducing the data anonymization burden and increasing the usefulness of the anonymized data. As will be described in greater detail below, e.g., see method 200, these techniques, in some preferred approaches, include inferring the data types and patterns of data to make the anonymization process much simpler for the data owners. For instance, all sensitive data can easily be replaced with a predetermined symbol, e.g., ?, instead of anonymizing differently for each data type. Although the data is anonymized completely, the techniques described herein are able to infer properties of the anonymized data based on determined structure and context of the data. For example, a conclusion may be made that a certain anonymized data field contains a user name based on the field name, even if the original user name has been removed. These techniques, in some preferred approaches, additionally and/or alternatively include replacing the anonymized values with synthetic data that mimics the characteristics of real data. The anonymized data is used as a structured data template and fills in anonymized values with replacement values that are automatically generated or obtained from non-anonymized data with a similar distribution. For instance, an anonymized first name can be replaced with a first name obtained from a public list of first names. Accordingly, these techniques enable collaborative training between untrusted parties, a data owner and a model trainer.

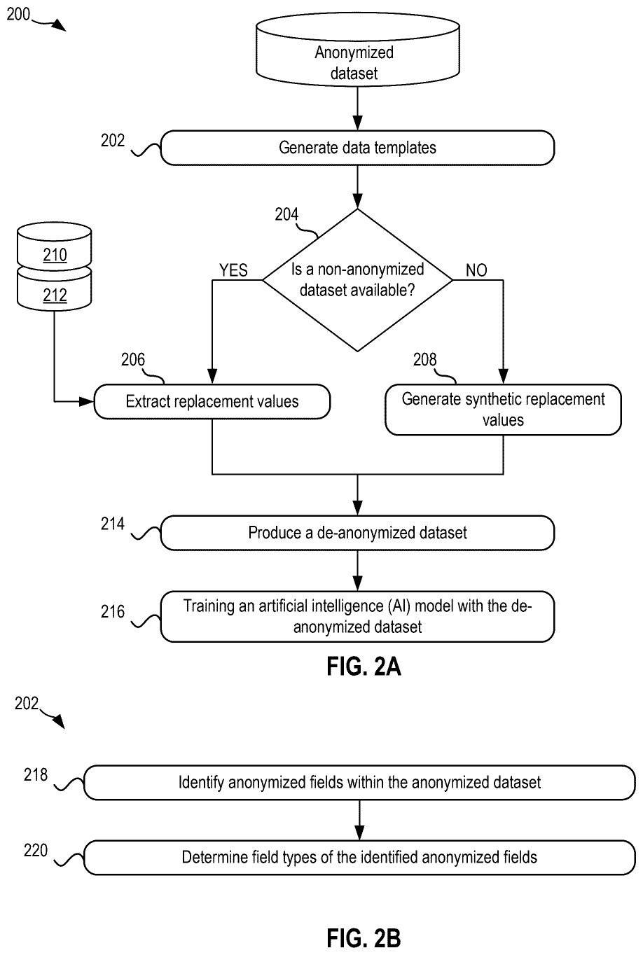

Now referring to FIG. 2A, a flowchart of a method 200 is shown according to one embodiment. The method 200 may be performed in accordance with aspects of the present invention in any of the environments depicted in FIGS. 1-3, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Method 200 includes techniques for generating synthetic data from anonymized data. Accordingly, in some preferred approaches, method 200 includes obtaining and/or gaining access to anonymized data, e.g., see Anonymized dataset. In some preferred approaches, the anonymized dataset includes structured data, e.g., structured forms, paragraphs of sentences, unsegmented strings of words, etc. It should be noted that the anonymized dataset may be defined as a collection of information in which at least some portion(s) of the dataset are already anonymized, e.g., private data that has been anonymized. For context, private data may include any type of data that is subject to protections by a governing entity and/or designated for such protection, e.g., bank account information, social security numbers, passwords, etc. Furthermore, in some approaches, at least some portion(s) of the dataset are not anonymized, e.g., data remains in an original state based on the data not being private data. However, in preferred approaches, the structured nature of the anonymized dataset survives any anonymization process applied to the dataset. For example, for a form, the structuring of the form and different arrangements of text and headings are preferably preserved in the anonymized dataset despite anonymization being applied to some portions of data therein.

Operation 202 includes generating data templates. For context, the data templates may be defined as results of analyzing the anonymized dataset. Looking to FIG. 2B, exemplary sub-operations of generating data templates are illustrated in accordance with one embodiment, one or more of which may be used to perform operation 202 of FIG. 2A. However, it should be noted that the sub-operations of FIG. 2B are illustrated in accordance with one embodiment which is in no way intended to limit the invention.

In some approaches, the generating comprises identifying anonymized fields within the anonymized dataset, e.g., see sub-operation 218. In some approaches, a trained artificial intelligence model of a type that would become apparent to one of ordinary skill in the art after reading the descriptions herein may be used to identify the anonymized fields (based on inspecting the anonymized dataset for the anonymized fields). These fields may be identified based on contours, e.g., boxes, in some approaches, while in some other approaches, these fields are identified by visually clustering different portions within the anonymized dataset. In yet some other approaches, these fields may be identified based on the types of values located therein. Various indicators of anonymized fields that may be identified within the anonymized dataset are described below. Note that, for identified anonymized fields (such as based on scanning of the anonymized dataset) anonymized data values may be identified and replaced with predetermined placeholder values, characters, etc.

In some approaches, a first anonymized field that may be identified within the anonymized dataset is based on wildcard characters. Anonymized fields may be identified as including wildcard characters, e.g., such as predetermined symbols: ?, *, %, #, etc. These wildcard characters may be listed in a plurality of data fields within the anonymized dataset.

In some other approaches, another of the anonymized fields that may additionally and/or alternatively be identified within the anonymized dataset is based on repeating and/or prevalent characters, e.g., the same data value is observed across most or all data samples for the same data field.

In yet another approach, another of the anonymized fields that may additionally and/or alternatively be identified within the anonymized dataset is based on the use of common anonymized values. Examples of such values include, e.g., John Doe, Jane Doe, placeholder_name, 123 Main Street, Anytown, etc.

In yet another approach, another of the anonymized fields that may additionally and/or alternatively be identified within the anonymized dataset is based on impossibilities. For example, such an anonymized field may be determined to use impossible values, e.g., a date field that uses a year in the future.

Another of the anonymized fields that may additionally and/or alternatively be identified within the anonymized dataset, in one approach, is based on use of a detectable mismatch. In such an approach, the anonymized field may be determined to include a value that does not match the data type, e.g., a string value for a number data field. Another mismatch type of the anonymized fields may use a value that does not match the data field type, e.g., an identified hash value for a name field.

In yet another approach, another of the anonymized fields that may additionally and/or alternatively be identified within the anonymized dataset is based on a lack of data being detected within an anonymized field, e.g., a box of a form is determined to be empty (not include a value).

Exemplary sub-operations of generating data templates may, in some approaches, additionally include determining field types of the identified anonymized fields, e.g., see sub-operation 220. Regarding anonymized field type identification, in response to a determination that the anonymized data does not provide the field type explicitly, this sub-operation may, in some approaches, include first determining the data type based on contextual signals. For example, in some approaches, the determining the field types comprises analyzing surrounding context of the anonymized fields within the anonymized dataset. Examples of this context includes, e.g., the data field name, non-anonymized data values for related data fields, etc.

In some approaches, the determining the field types comprises analyzing metadata associated with the anonymized dataset. The metadata, in some approaches, includes database schema information and/or names of the anonymized fields. For example, in approaches involving databases, the database schema may be leveraged (by an AI model trained to perform the operations of method 200) to derive data fields and types, and relationships among the fields and types may be used to generate precise data templates. For program languages and query languages, such as SQL, language parsers may be utilized to build an abstract syntax tree (AST) from the target language code while analyzing the anonymized dataset. From the structure of the AST and relationships between nodes of the AST, in some approaches, data field types of the anonymized data may be inferred even from complex statements such as nested conditions. Accordingly, in some approaches, the determining the field types comprises inferring the field types based on the analyzed metadata and relationships between the anonymized fields. Such inferences may, in some approaches, be drawn from applying inferencing models of a type that would become apparent to one of ordinary skill in the art after reading the descriptions herein.

For each data field type collected during template generation, method 200 preferably includes finding replacements for the anonymized values. More specifically, method 200 preferably includes generating replacement values for the anonymized fields. Although a given value is anonymized, the properties (e.g. the data type or data field type) are known based on the techniques described herein. This knowledge is used to generate replacement values.

In order to generate replacement values, one or more sources of the replacement values may be considered. For example, in some approaches, database(s) may already exist from which the replacement values may be obtained from. For example, in some approaches, method 200 includes determining whether a non-anonymized dataset is available for the generating the first replacement values for the anonymized fields, e.g., see decision 204. One example of such a non-anonymized dataset includes documentations and/or manuals 210. Another example of such a non-anonymized dataset includes a non-anonymized dataset 212 which may be maintained by the model trainer or be a publicly available resource.

In response to a determination that the non-anonymized dataset is available, e.g., as illustrated by the “YES” logical path of decision 204, method 200 includes extracting the first replacement values from the non-anonymized dataset for the generating the first replacement values for the anonymized fields, e.g., see operation 206.

In contrast, in response to a determination that the non-anonymized dataset is not available, e.g., as illustrated by the “NO” logical path of decision 204, method 200 includes generating synthetic values, e.g., see operation 208. A large language model (LLM) may, in some approaches, be used to produce the first replacement values for the operation of generating the first replacement values for the anonymized fields. For example, an LLM trained with name data can be used to create human names that can be used to replace anonymized values of an anonymized field determined to be associated with a particular type or class of human name. In another example, in response to a determination that the anonymized value is an file name, the LLM may be caused to randomly generate names for files during synthetic data generation.

It should be noted that although an LLM is relied upon in the case specific example above, in some other approaches, any synthetic data generation pipeline (other than sampling from a non-anon dataset as detailed in another logical path of method 200) may additionally and/or alternatively be used for the synthetic data generation steps described above. In some other approaches, a pattern-based data generation process may additionally and/or alternatively be pursued, e.g., for SSN, IP address, Hash, etc. For instance, in response to a determination that the anonymized data values have an identified particular pattern, such as US telephone numbers, social security numbers or IP addresses, a value can be generated automatically based on the pattern.

It should be noted that synthetic data quality can be improved by ensuring that the replacement values come from a similar data distribution as the original de-anonymized data value (determined to have at least a predetermined degree of similarity). With additional data property information, a representative distribution may be inferred (e.g. a class or type of human names in the United States) to draw from. In an alternative approach, the data owner may be relied on to provide a representative distribution. Some data owners may also possess a small set of non-anonymized data. For example, a query platform may be searched to determine whether a library of common query patterns aggregated across users are available, which may contain real, but non-sensitive data values. These non-sensitive sources may be identified and considered as contextual signals to infer the underlying data distribution and/or as the seed examples for synthetic generation, in some approaches.

With the data templates and the replacement values for each data field type generated, synthetic data samples may then be generated, e.g., hereafter referred to as a de-anonymized dataset (see operation 214). This de-anonymized dataset is not de-anonymized in the sense that the private data of the dataset becomes available, but rather, the anonymized values that would otherwise serve little purpose to training a model are replaced with the synthetic replacement values that can be used to accurately train a model (as will be described in greater detail in operation 216).

In some approaches, producing a first de-anonymized dataset comprises replacing the anonymized fields in the data templates with the generated first replacement values.

It should be noted that, although descriptions above refer to a first de-anonymized dataset being produced, depending on the approach, more than one de-anonymized dataset may be produced, e.g., the first de-anonymized dataset, a second de-anonymized dataset, a third de-anonymized dataset, etc. For some approaches in which multiple de-anonymized datasets are produced, associated replacement values may be generated and used for producing different de-anonymized datasets. For example, in some approaches, second replacement values may be generated for the anonymized fields, and a second de-anonymized dataset may be produced. More specifically, the producing the second de-anonymized dataset comprises replacing the anonymized fields in the data templates with the generated second replacement values.

When generating different de-anonymized datasets, multiple different predetermined strategies may be considered. For example, in one approach, a comprehensive strategy includes generating every possible combination of data field replacement values for a given data template and enumerating these values across all data templates in order to produce a plurality of unique de-anonymized datasets. In another approach, a sampling-based strategy includes, for each data field in a given data template, sampling one or more replacement values and enumerating these values across a plurality of data templates to produce a plurality of de-anonymized datasets.

Operation 216 includes training an AI model with the first de-anonymized dataset. In approaches in which more than one de-anonymized dataset is produced, multiple de-anonymized datasets may be used to train the AI model, e.g., method 200 may additionally include training the AI model with the second de-anonymized dataset.

The AI model may be of a type that would become apparent to one of ordinary skill in the art after reading the descriptions herein. In one preferred approach, the AI model is a large language model (LLM).

The training of the AI model with the first de-anonymized dataset, in some approaches, comprises causing, e.g., instructing, the AI model to ingest the first de-anonymized dataset. An output of the AI model may be used to determine whether the AI model has surpassed a predetermined dynamic threshold of accuracy, where the output is based on the ingestion of the first de-anonymized dataset. In response to a determination that the AI model has surpassed the predetermined dynamic threshold of accuracy, the AI model is deployed in a target environment. This target environment may include, e.g., a data management and/or storage environment, a server of a governing entity that audits data privacy practices, a data anonymization server, etc.

Accuracies of the AI model are greater than would otherwise be achieved using the original anonymized dataset because context extracted from the anonymized dataset is used to transform the dataset with enriched data. This preserves processing potential of a computer architecture that is used to perform the operations described herein. Furthermore, these techniques enable the AI model to be deployed relatively quicker.

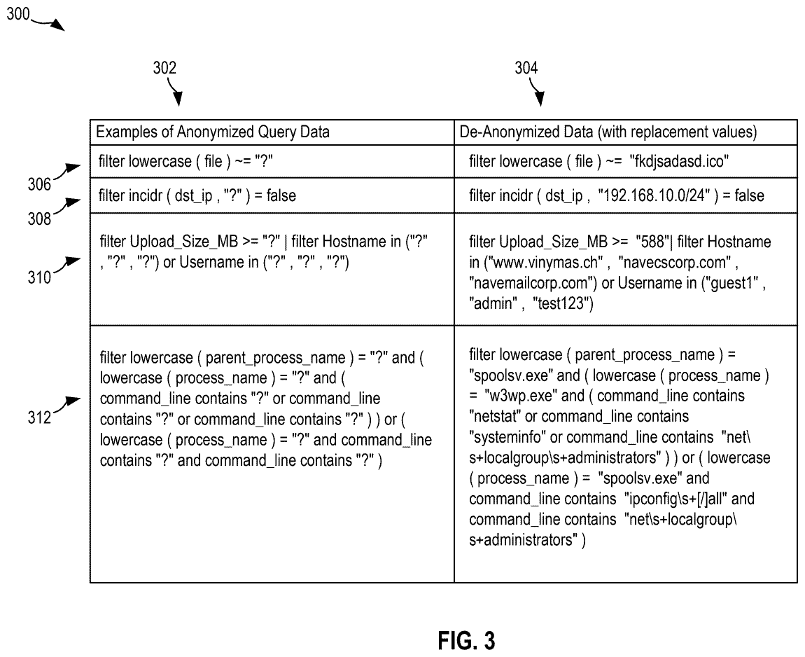

FIG. 3 depicts a table 300, in accordance with one embodiment. As an option, the present table 300 may be implemented in conjunction with features from any other embodiment listed herein, such as those described with reference to the other FIGS. Of course, however, such table 300 and others presented herein may be used in various applications and/or in permutations which may or may not be specifically described in the illustrative embodiments listed herein. Further, the table 300 presented herein may be used in any desired environment.

The contents of table 300 may be identified within structured data samples of an anonymized dataset that are leveraged to identify data values and create data templates. It should be noted that techniques described above may be used to determine data types of data of such a dataset to refer to how the value is interpreted programmatically, e.g., text/string, number/integer, etc., and data field type to refer to a higher-level representation, e.g., name, hash value, IP Address.

Table 300 includes a first column 302 that includes examples of query data with anonymized values, and a second column 304 that includes examples of the query data with de-anonymized data (the anonymized values are replaced with generated replacement values). For example, in a first row 306 of the table 300, the value of a filename is anonymized with the value “?”. This would provide little training context for an AI model, and therefore, using the techniques described herein, this value is replaced with a replacement value that resembles a file name, e.g., see “fkdjsadasd.ico.” Similarly, in a second row 308 of the table 300, the value of a Classless Inter-Domain Routing (CIDR) address is anonymized with the value “?”. This would provide little training context for an AI model as the AI model would otherwise be inaccurately trained to recognize the value “?” as a CIDR address. In order to refine an accuracy of the model, using the techniques described herein, this value is replaced with a replacement value that resembles an actual CIDR address, e.g., see “192.168.10.0/24”. Note that the CIDR address of the replacement value is likely not the CIDR address that was originally anonymized with the “?” value.

In a third row 310 of the table 300, the values of a hostname and a username are anonymized with the values “?”, “?”, “?”. This would provide little training context for an AI model as these values do not resemble typical hostnames and usernames. Accordingly, using the techniques described herein, these values are replaced with replacement values that resemble hostnames, e.g., see “www.vinymas.ch,” “navecscorp.com,” etc., and usernames, e.g., see “guest1”, “admin”, etc. Finally, in a fourth row 312 of the table 300, the values of various types of command names (such as command process names) are anonymized with the values “?”. Using the techniques described herein, these values are replaced with replacement values that resemble command process names, e.g., see “spoolsv.exe,” “w3wp.exe,” etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating data templates, wherein the generating comprises:
identifying anonymized fields within an anonymized dataset, and
determining field types of the identified anonymized fields;
generating first replacement values for the anonymized fields;
producing a de-anonymized dataset, wherein the producing the first de-anonymized dataset comprises replacing the anonymized fields in the data templates with the generated first replacement values; and
training an artificial intelligence (AI) model with the first de-anonymized dataset.

2. The method of claim 1, wherein the determining field types comprises:
analyzing metadata associated with the anonymized dataset;
analyzing surrounding context of the anonymized fields within the anonymized dataset; and
inferring the field types based on the analyzed metadata and relationships between the anonymized fields.

3. The method of claim 2, wherein the metadata includes database schema information and/or names of the anonymized fields.

4. The method of claim 1, wherein the training the AI model with the first de-anonymized dataset comprises:
causing the AI model to ingest the first de-anonymized dataset;
using an output of the AI model to determine whether the AI model has surpassed a predetermined dynamic threshold of accuracy, wherein the output is based on the ingestion of the first de-anonymized dataset; and
in response to a determination that the AI model has surpassed the predetermined dynamic threshold of accuracy, deploying the AI model in a target environment.

5. The method of claim 4, wherein the AI model is a large language model (LLM).

6. The method of claim 1, further comprising:
determining whether a non-anonymized dataset is available for the generating the first replacement values for the anonymized fields; and
in response to a determination that the non-anonymized dataset is available, extracting the first replacement values from the non-anonymized dataset for the generating the first replacement values for the anonymized fields.

7. The method of claim 6, further comprising:
in response to a determination that the non-anonymized dataset is not available, using a large language model (LLM) to produce the first replacement values for the generating the first replacement values for the anonymized fields.

8. The method of claim 6, further comprising:
generating second replacement values for the anonymized fields;
producing a second de-anonymized dataset, wherein the producing the second de-anonymized dataset comprises replacing the anonymized fields in the data templates with the generated second replacement values; and
training the AI model with the second de-anonymized dataset.

9. A computer program product comprising:
one or more computer-readable storage media; and
program instructions stored on the one or more computer-readable storage media to perform operations comprising:
generating data templates, wherein the generating comprises:
identifying anonymized fields within an anonymized dataset, and
determining field types of the identified anonymized fields;
generating first replacement values for the anonymized fields;
producing a first de-anonymized dataset, wherein the producing the first de-anonymized dataset comprises replacing the anonymized fields in the data templates with the generated first replacement values; and
training an artificial intelligence (AI) model with the first de-anonymized dataset.

10. The computer program product of claim 9, wherein the determining field types comprises:
analyzing metadata associated with the anonymized dataset;
analyzing surrounding context of the anonymized fields within the anonymized dataset; and
inferring the field types based on the analyzed metadata and relationships between the anonymized fields.

11. The computer program product of claim 10, wherein the metadata includes database schema information and/or names of the anonymized fields.

12. The computer program product of claim 9, wherein the training the AI model with the first de-anonymized dataset comprises:
causing the AI model to ingest the first de-anonymized dataset;
using an output of the AI model to determine whether the AI model has surpassed a predetermined dynamic threshold of accuracy, wherein the output is based on the ingestion of the first de-anonymized dataset; and
in response to a determination that the AI model has surpassed the predetermined dynamic threshold of accuracy, deploying the AI model in a target environment.

13. The computer program product of claim 12, wherein the AI model is a large language model (LLM).

14. The computer program product of claim 9, wherein the operations further comprise:
determining whether a non-anonymized dataset is available for the generating the first replacement values for the anonymized fields; and
in response to a determination that the non-anonymized dataset is available, extracting the first replacement values from the non-anonymized dataset for the generating the first replacement values for the anonymized fields.

15. The computer program product of claim 14, wherein the operations further comprise:
in response to a determination that the non-anonymized dataset is not available, using a large language model (LLM) to produce the first replacement values for the generating the first replacement values for the anonymized fields.

16. The computer program product of claim 14, wherein the operations further comprise:
generating second replacement values for the anonymized fields;
producing a second de-anonymized dataset, wherein the producing the second de-anonymized dataset comprises replacing the anonymized fields in the data templates with the generated second replacement values; and
training the AI model with the second de-anonymized dataset.

17. A computer system comprising:
a processor set;
one or more computer-readable storage media; and
program instructions stored on the one or more computer-readable storage media to cause the processor set to perform operations comprising:
generating data templates, wherein the generating comprises:
identifying anonymized fields within an anonymized dataset, and
determining field types of the identified anonymized fields;
generating first replacement values for the anonymized fields;
producing a first de-anonymized dataset, wherein the producing the first de-anonymized dataset comprises replacing the anonymized fields in the data templates with the generated first replacement values; and
training an artificial intelligence (AI) model with the first de-anonymized dataset.

18. The computer system of claim 17, wherein the determining field types comprises:
analyzing metadata associated with the anonymized dataset;
analyzing surrounding context of the anonymized fields within the anonymized dataset; and
inferring the field types based on the analyzed metadata and relationships between the anonymized fields.

19. The computer system of claim 17, wherein the training the AI model with the first de-anonymized dataset comprises:
causing the AI model to ingest the first de-anonymized dataset;
using an output of the AI model to determine whether the AI model has surpassed a predetermined dynamic threshold of accuracy, wherein the output is based on the ingestion of the first de-anonymized dataset; and
in response to a determination that the AI model has surpassed the predetermined dynamic threshold of accuracy, deploying the AI model in a target environment.

20. The computer system of claim 17, wherein the operations further comprise:
determining whether a non-anonymized dataset is available for the generating the first replacement values for the anonymized fields; and
in response to a determination that the non-anonymized dataset is available, extracting the first replacement values from the non-anonymized dataset for the generating the first replacement values for the anonymized fields.
